(19) United States
(12) Patent Application Publication
(10) Pub. No.: US 2011/0153739 A1
(43) Pub. Date: Jun. 23, 2011

(54) Proximity Sensor Enabled eService Connector System

(75) Inventor: Richard A. McCoy, Stevensville, MI (US)

(73) Assignee: WHIRLPOOL CORPORATION, Benton Harbor, MI (US)

(21) Appl. No.: 12/643,141

(22) Filed: Dec. 21, 2009

(51) Int. Cl. G06F 15/16; H01H 35/00

(52) U.S. Cl. 709/204; 307/116

(57) ABSTRACT

Systems and components for providing or receiving an eService, such as acoustic, thermal and illumination service. A service switch is provided for selectively transferring the eService from the host or other eService source to the eService consumer. The service switch is activated to transfer an eService in response to detection of a proximity target associated with an eService consumer by a proximity source associated with an eService provider.

### BACKGROUND

Traditionally, appliances, consumer electronics devices, and other useful household equipment had been located in different rooms dedicated to the function supported by the appliance, consumer electronic device, and/or household equipment. The kitchen has traditionally been limited to a space for preparing and eating meals and consequently has mostly been occupied by cabinetry and large home appliances such as refrigerators, dishwashers, and ovens. The family room has been designated as a place for leisure activities, and so most entertainment devices, such as televisions and video games are commonly found here. Laundry rooms normally house a clothes washing machine, a clothes dryer, and an iron. Devices such as personal computers and printers are often located in another room, such as a dedicated home office or bedroom.

Consumers increasingly own multiple hand-held or portable consumer electronic devices, such as laptops, cell phones, PDA's, and digital music players. These devices are typically used in many different rooms in the house and are often carried from room to room throughout the home. Consumers tend to eat, meet and entertain in the kitchen, not just in the dining room and family room. In fact, the kitchen is often the hub of most household activity. Consumers also tend to work in every room of the home with the adoption of laptop computers and wireless networks. Therefore, there is a trend for consumers to perform non-traditional functions in a household room designed for a traditional function. The present invention recognizes this trend and attempts to support the trend.

### BRIEF SUMMARY

The present disclosure describes eService connector systems and components for connecting portable devices to a host.

According to one aspect of the invention, a system for coupling eService communicating devices comprises a first eService connector component associated with a first eService communicating device having a proximity target, a second eService connector component operably engageable with the first eService connector component, the second eService connector component associated with a second eService communicating device having a proximity sensor, an eService pathway passing an eService between the first and second eService connector components when the eService components are interengaged, and a service switch operably associated with the proximity sensor to selectively permit the flow of the eService along the eService pathway when the proximity sensor detects the proximity target.

According to another aspect of the invention, an eService connector component connects a portable device to a host, the portable device having a proximity target and an eService communicating device. The eService connector component comprises a proximity sensor capable of detecting the proximity target, an eService pathway interconnecting the eService communicating device and the eService connector component, and a service switch selectively permitting the flow of the eService along the eService pathway in response to detection of a proximity target by the proximity sensor.

According to yet another aspect of the invention, a portable accessory device is used in association with a host having an eService provider, a first eService connector component, and an eService line selectively providing an eService to the first eService connector component in response to a proximity sensor detecting a proximity target. The accessory device comprises an eService consumer, a second eService connector component, an eService pathway for interconnecting the eService consumer and the second eService connector component, and a proximity target capable of activating a proximity sensor to activate a service switch, wherein the activation of the service switch permits the provision of the eService from the second eService connector component to the eService consumer along the eService pathway.

According to still another aspect of the invention, an adapter comprises a second host eService connector component engageable with the first host eService connector component of a host, a second device eService connector component engageable with the first device eService connector component of a portable eService communicating device, an eService pathway interconnecting the second host eService connector component and the second device eService connector component for the transfer of an eService therealong, and a second contactless proximity coupling device operably associated with the second host eService connector component, the second contactless proximity coupling device being configured to engage the first contactless proximity coupling device when the first and second eService connector components are engaged to selectively permit the communication of the eService between the first eService communicating device and the second eService communicating device.

According to still another aspect of the invention, a second eService communicating device couples to a first eService communicating device having a first eService connector component, an eService receiver capable of receiving at least one eService, and a first service switch component. The second eService communicating device comprises a second eService connector component comprising an eService transmitter capable of transmitting the at least one eService, and a second service switch component engageable with the first service switch component to selectively control the transmission of eService from the second eService connector component in response to the engagement between the second and the first service switch components.

According to still another aspect of the invention, a system of communicating devices comprises an accessory having a first eService communicating device, the first eService communicating device comprising a first eService connector component comprising an eService receiver capable of receiving at least one eService and a first service switch component, and a host having an eService coupling system, the coupling system comprising a second eService connector component comprising an eService transmitter capable of transmitting the at least one eService and a second service switch component engageable with the first service switch component to selectively control the transmission of eService from the second eService connector component.

According to still another aspect of the invention, a host coupled with an accessory device comprises an eService connector component, an eService transmitter operably connected to the eService connector component and capable of transmitting the at least one eService to the accessory device, and a service switch component to selectively control the transmission of eService from the appliance to the accessory device

### BRIEF DESCRIPTION OF THE DRAWINGS

In the drawings:

FIG. 1 is a perspective view of a modular system according to one embodiment of the invention employing a proximity sensor enabled eService connector system for connecting an accessory device to a host.

FIG. 2 is a front elevational view of the modular system of FIG. 1 showing the accessory device attached to the host.

FIG. 3 is a side elevational view of the modular system of FIG. 1 showing the accessory device removed from the host.

FIG. 4 is partial top rear perspective view of the modular system of FIG. 1 with the accessory device removed from the host, showing a host portion of the proximity sensor enabled eService connector system, with portions shown schematically.

FIG. 5 is a bottom perspective view of the accessory device of FIG. 1 showing an accessory device portion of the proximity sensor enabled eService connector system.

FIG. 6 is a partial cross-sectional view of the proximity sensor enabled eService connector system of FIG. 1 using a magnetic proximity target and a magnetic proximity sensor, shown with the accessory device portion of the eService connector system positioned for engagement with the host portion of the eService connector system.

FIG. 7 is a partial cross-sectional view similar to FIG. 6, showing the accessory device portion of the eService connector system engaged with the host portion of the eService connector system.

FIG. 8 schematically illustrates a thermal eService provider.

FIG. 9 schematically illustrates an acoustical eService provider.

FIG. 10 schematically illustrates an illumination eService provider.

FIG. 11 schematically illustrates an eService provider and consumption system.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or to otherwise limit or restrict the claims to the precise forms and configurations shown in the drawings and disclosed in the following detailed description.

The drawings and the following detailed description relate generally to systems of eService connectors for coupling an eService provider with an eService consumer.

In the drawings generally, a service provider within a host creates a first service, which is delivered to an eService transmitter. The first service may be delivered to the transmitter in any appropriate form that may be used by the transmitter, such as in the form of electrical power, an electromagnetic wave, mechanical power, or a compression wave, for example. If the first service is an eService, the eService transmitter may simply transmit the eService as received or may modify it in form, such as frequency, type, intensity, polarity, etc. If the first service is not in the form of an eService, then the eService transmitter or another device between the service provider and the eService transmitter uses the first service to create the eService for transmission.

An eService receiver associated with an accessory device receives the eService and either consumes the eService, retransmits the eService, or provides a second service to a service consumer associated with the accessory device. If the service consumer is an eService consumer, then the eService receiver may simply retransmit or pass the received eService to the eService receiver or may modify it in form. If the service consumer is not an eService consumer, than the eService receiver or another device uses the eService to create the service used by the service consumer.

The following definitions apply to terms that may be used in the specification and the claims, unless otherwise noted.

As used herein, an “eService” is a useful wave-based functionality, such as thermal energy, illumination, and sound, which may be communicated from one device to another device. An eService may be provided continuously, for specified times, for specified amounts, and/or for the duration of certain events, such as the duration of a user function or a device operation, to provide sound, heat, cooling, or illumination.

A “service” is a useful functionality that may be communicated from one device to another device, and can include an eService, but can also include other useful functionalities such as electrical power, electronic data, mechanical support, mechanical power, mechanical motion, fluid power, or a substance, as well as others.

The term “coupled”, and any variation thereof, as used herein, includes any type of connection that permits transfer of a service, such as an eService, between two devices. The term “coupled” does not require a physical connection between the two devices, so long as the coupling permits transfer of an eService. The term “coupled” includes both fixed and removable coupling, as well as both continuous and intermittent coupling.

The term “communication”, and any variation thereof, as used herein, is the coupling of two devices to supply a service, including an eService, from at least one of the devices to the other of the devices, such as through directly connected electronic lines or plumbing lines, or through contactless communication (also referred to as contactless transmission). Contactless communication can include any types of contactless service communication, including, without limitation for illustration purposes, electromagnetic transmission, acoustical transmission, and magnetic fields. Service communication includes supplying or receiving any service. As used herein, communication of eService includes both uni-directional and multi-directional communication between any two devices, either directly or through an adapter, as defined herein.

“EService communication” as used herein is the communication of an eService including any coupling of two devices to supply an eService from at least one of the devices to the other of the devices through a contact or contactless coupling, and includes acoustic, thermal and illumination communication.

“Illumination communication” as used herein is the coupling of two devices to supply illumination from at least one of the devices to the other of the devices, either contactlessly or through contacting components, such as through the coupling of two light pipes or a light transmitter and receiver combination, such as opto-isolator.

“Acoustic communication” as used herein is the coupling of two devices to supply sound, compression waves, or vibration from at least one of the devices to the other of the devices, either contactlessly or through contacting components.

“Thermal communication” as used herein is the coupling of two devices to supply heating or cooling through radiation, conduction, or convection from at least one of the devices to the other of the devices, either contactlessly or through contacting components.

The terms “provide,” and “supply” and any variation thereof, are used herein to denote a source of the service relative to a device receiving the service. Neither term is limited to the original source of the service. A device that provides or supplies a service may simply be passing on the service from the original source, such as a residential power or water utility system or the internet. For example, a device that provides an electrical power service may pass on electricity it receives from a household outlet. However, the device may alternatively or additionally provide another eService that originates with the device, such as a data service.

The term “receive” and any variation thereof, is used herein to denote receipt of a service relative to the device providing the service. The term is not limited to the ultimate consumer of the service. A device that receives the service may simply be passing on the service from the source, such as an appliance, to a device that will consume, as hereinafter defined, the service. The device which receives a service is not necessarily the end consumer of the service.

The term “consume” and any variation thereof, as used herein denotes the act of employing, using, storing, or dispensing at least a portion of the service received in connection with performing a function, such as using a power, illumination or acoustic service to operate a speaker or video display.

A “useful device” as used herein is a device that is capable of performing a useful physical or virtual function either alone or in combination with another device.

A “service consumer” as used herein is any useful device that employs, uses, stores, or dispenses a service in connection with performing a physical or virtual function. A service consumer may be, for example, a consumer electronic device, a remote user interface, a source of consumer information, a reader, such as a bar code, optical scanner or RFID reader, a sensor device, a smart utensil, a portable appliance, an additional smart coupling device, a remote controller, a network binder, a cycle accessory, a resource controller, such as an energy controller, a communicator, such as an audible accessory, an access or payment system, such as a smart card system permitting access to a host device, a sales demonstration device, an eService holder, such as a battery, a dispenser, a media content holder, a resource controller, such as a water controller, a dispenser, a filter, a water filter, an air filter, a detergent dispenser, a drink dispenser, a detergent cartridge, a substance holder, such as a bottle, a jug, or a cycle accessory.

An “eService consumer” as used herein is any service consumer that uses an eService, such as a device using an illumination service to provide or enhance visibility, or a device using a thermal service to change or maintain a temperature for a container or a substance.

A “service provider” as used herein is any device that is capable of providing or supplying a service to another device.

An “eService communicating device” as used herein is any device that is capable of communicating an eService with another device, and may be an eService provider or an eService consumer.

A “host” as used herein is a service provider that has a primary function independent of providing a service. For example, the host may be an appliance and the primary function can be performing a series of steps to conduct a useful cycle of operation. The appliance may be a conventional household appliance, such as a refrigerator performing a cooling cycle or an ice making cycle. Other examples of appliances that may be hosts include, but are not limited to, a freezer, a conventional oven, a microwave oven, a dishwashing machine, a stove, a range, an air conditioner, a dehumidifier, a clothes washing machine, a clothes dryer, a clothes refreshing machine, and a non-aqueous washing apparatus, or any combination thereof. Alternatively, the host may be a fixture such as a water softener, a water heater, a furnace, pool water treatment equipment, or an HVAC system. The host may be a small device such as a thermostat, a blender, a mixer, a toaster, a coffee maker, a trash compactor, an air purifier, an iron, a vacuum cleaner, or a robot. The host can alternatively comprise a structural feature of a building, such as a wall, cabinet, or door. The host may be a service consumer in addition to being a service provider. For example, the host may provide an illumination service while receiving or while supplying and receiving a data service.

As used herein, the terms “accessory” or “accessory device” refer to any useful device that may be used primarily in conjunction with a host to enhance, supplement, regulate or monitor the functionality of the host. An accessory device may be a service provider, a service consumer, or both. Examples of an accessory device include, but are not limited to, a television, a video camera, a video recorder, a personal computer, a notebook computer, a computer monitor, a video display, a keyboard, a printer, copying equipment, a calculator, a facsimile machine, a scanner, a digital storage device, a wireless transceiver, an internet router, a power supply, a data recorder, an answering machine, a telephone, a cordless telephone, a cellular telephone, a video game system, a personal digital assistant, a DVD player, a VHS player, a VCR, a cassette deck, an 8 mm video player, a CD player, a Blackberry®, a smartphone, a smoke detector, a portable digital video player, an MP3 player, a radio, other music players, an audio speaker, a digital picture frame, a weather station, and a scale or balance.

A “portable device” as used herein is a useful device that is designed to be moveable by a user during its useful life between a use location and a storage location or alternative use location. A portable device can be an accessory device.

An “independent device” as used herein is a useful device that provides a useful function without being connected to a service provider. In some cases, the primary function of the independent device is different from the primary function of a host from which the independent device may receive a service. The independent device may be a consumer electronic device, such as portable communication, entertainment, informational or educational devices.

A “dependent device” as used herein is a useful device that provides a useful function only when connected to a service provider. A dependent device may be a service consumer. Examples of dependent service consumers that may be coupled to a host include a remote user interface (UI), a consumable reader, a cooking sensor, a smart pan or pot, a smart dimmer, a cycle accessory, an energy controller, an audible accessory, a laundry payment or smart card system, a sales demonstration unit, or a service laptop or other service client.

A “service connector system” or “service coupling system” as used herein is a connector system having at least two separate service connector components, each associated with a useful device. The service connector components cooperate with one another to couple the useful devices to facilitate communication of a service between the useful devices. A service connector system that facilitates communication of an eService between useful devices may alternately be referred to as an “eService connector system”. A service connector system may carry multiple services, including multiple eServices or an eService and another service, such as power or substance.

A “switched service connector system” as used herein is a service connector system having a switching capability in at least one of the service connector components operable to selectively permit the communication of a service between the components of the service connector. If the service connector system is an eService connector system, the switched service connector system may alternately be referred to as a “switched eService connector system”.

A “service switch” as used herein is any component used to selectively permit the communication of a service between components of a service connector system. A service switch may be associated with more than one type of service. For example, an electromagnetic service switch may be associated with, integrated with, or comprise a service switch or may be independent of a service switch. A service switch that permits communication of an eService may alternately be referred to as an “eService service switch”.

A “plug” as used herein is a generally male service connection component.

A “receptacle” as used herein is a generally female service connection component.

A “service line” or “service pathway” as used herein is a line or pathway for transferring a service from one location to another. The service line may have any of a variety of configurations depending on the type of service being transferred, including, but not limited to, a pipe, a conduit, a wire, a tube, a channel, and a fiber optic cable.

An “eService line” or “eService pathway” as used herein is a service line or pathway for transferring an eService from one location to another. The eService line may have any of a variety of configurations, including, but not limited to, a pipe, a conduit, a wire, a tube, a channel, and a fiber optic cable. For example, for thermal service communication, an eService line may include a tube, a passageway, or a conductive path such as metal bar or heat pipe, or may include a radiation heat source and a radiation heat absorber. For illumination, an eService line may be a light pipe or a light sender and receiver. For acoustic service communication, an eService line may include a vibration conductive tube or wire, or may be a speaker and a microphone.

An “eService transmitter” as used herein is any device capable of receiving an eService from an eService provider and providing it to another device in the form of a wave.

An “eService receiver” as used herein is any device capable of receiving an eService in the form of a wave and consuming the eService or passing the eService to an eService consumer.

“Wireless” refers to a type of communication in which power and/or data is transferred over a distance without the use of electrical conductors or wires. For example, electromagnetic waves, light waves, or acoustic waves can be used to carry power and/or data over a distance without using electrical conductors or wires.

A “proximity target” as used herein is any component or device that may be detected when positioned within a predetermined distance of an associated proximity sensor, defined below. A proximity target may be passive, such as visual target or a magnetic target formed of magnetic or magnetic responsive material. Other examples of passive proximity targets may include a conductive component or surface capable of cooperating with a magnetic field, a current, or a voltage provided by a proximity sensor. A proximity target may alternatively be active or powered such as an electromagnet, a generator of a magnetic field, a current, a voltage or an acoustic wave. An active proximity target may alternatively provide a powered readable display or dispense a detectable chemical.

A “proximity sensor” as used herein is any component or device that may detect an associated proximity target when the proximity target is within a predetermined distance of the proximity sensor. A proximity sensor may detect, for example, a change in an electromagnetic field, an electromagnetic wave, an acoustic wave, a visual target a chemical component, an electrical signal, a change in voltage, a change in current, a change in frequency, a change in resistance, a change in inductance, a change in capacitance, a mechanical signal, a change in pressure, a displacement, a vibration, and the presence of a chemical, A proximity sensor may be active or passive, such as a magnetic sensor of magnetic or magnet responsive material, or may alternatively be active. Examples of active sensors include active magnetic sensors, light sensors, optical sensors, acoustic sensors, electromagnetic sensors, chemical sensors and thermal sensors. Examples of magnetic sensors include magnets and magnetic responsive components. Examples of optical sensors include infrared sensors, photoelectric sensors, fiber optic sensors, photo resistors, photovoltaic sensors, photo diodes and cameras. Examples of electromagnetic sensors include radio receivers, radar sensors, Hall Effect sensors, inductive sensors, capacitive sensors, variable reluctance sensors and eddy current sensors. Examples of acoustic sensors include ultrasonic sensors and microphones. A contact proximity sensor detects a proximity target by touching the proximity target. A contactless proximity sensor detects the proximity target through a wireless or contactless means. For example, magnetic flux can be used as the signaling mechanism between a contactless proximity sensor and a contactless proximity target.

As used herein, the term “proximity system” is a system that uses a “proximity switch” operated by a plurality of “proximity coupling components,” each associated with a different parent device, for determining that the parent devices are in proximity with each other. Parent devices are usually paired, examples of which include a service provide and a service consumer, a host and an accessory, and a host and an adapter. Proximity coupling components may include a proximity target associated with one parent device to actively or passively provide an indication of the presence of the one parent device, and a proximity sensor associated with the other parent device that is responsive to the presence of the proximity target to activate the proximity switch. The proximity switch may be used to provide a signal or message indicative of the proximity of two parent devices, or may directly or indirectly regulate the flow of a service along a service line. The proximity systems disclosed herein employ contactless proximity systems, wherein the proximity target and proximity switch use contactless or wireless means to detect the proximity of the two parent devices.

An “adapter” as used herein is an intermediate device that may be provided between a first and second useful device, such as between a host and an accessory, to facilitate the communication of services between the first and second useful devices. An adapter may receive a service from the first useful device and provide a modified version of the service to the second useful device, for example, by providing an electrical power service using a different voltage or providing a data service using a different data structure or signal type. In some applications, multiple adapters may be interposed between two accessory devices. In other applications, three or more devices may be coupled to a single adapter, such as between a host and two accessories. In some applications, the adapter may itself be an accessory device providing a useful function not provided by the accessory devices coupled to it. An adapter may optionally include a transformative component that transforms a service from a service provider to a different service, which is supplied to a service consumer. This may be useful when the service from the service provider is not compatible with the service consumer. The transformative component can be configured to transform the service into a compatible form for the service consumer. Examples of transformative components are protocol converters, power transformers, or other devices that convert substance, energy, or data from a first form to a second form.

A “functional unit” as used herein is any adapter coupled to a useful device, which together provide functionality that neither the adapter nor the useful device can alone provide. Any functional unit itself is also included within the meaning of the term “useful device”. In some cases, it is contemplated that a dependent device may be coupled with an adapter that provides one or more eServices required by the dependent device to enable the functional unit to provide a useful function, in which case the functional unit also constitutes an independent device.

A “storage device” as used herein is any device capable of receiving an eService, storing the eService, and selectively dispensing the eService. A storage device may include, for example, a battery, a capacitor, a hard disk drive, an optical disc, such as CD, DVD, or Blue-ray Discs, a floppy disk, a ZIP disk, a minidisk, a solid state semiconductor memory, such as xD-Picture card, a MultiMediaCard, a USB flash drive, SmartMedia, an SD card, a miniSD card, an SDHC card, a microSD card, a TransFlash card, a CompactFlash I or II, a Secure Digital, or a Sony Memory Stick.

A “conversion device” as used herein is any device capable of converting the form of an eService or converting one eService to another eService. Examples of a conversion device include, but are not limited to, a generator, a motor, a piezoelectric device, a pneumatic device, an inverter, a lens, a filter, a prism, a transmitter, a speaker, and a resonator.

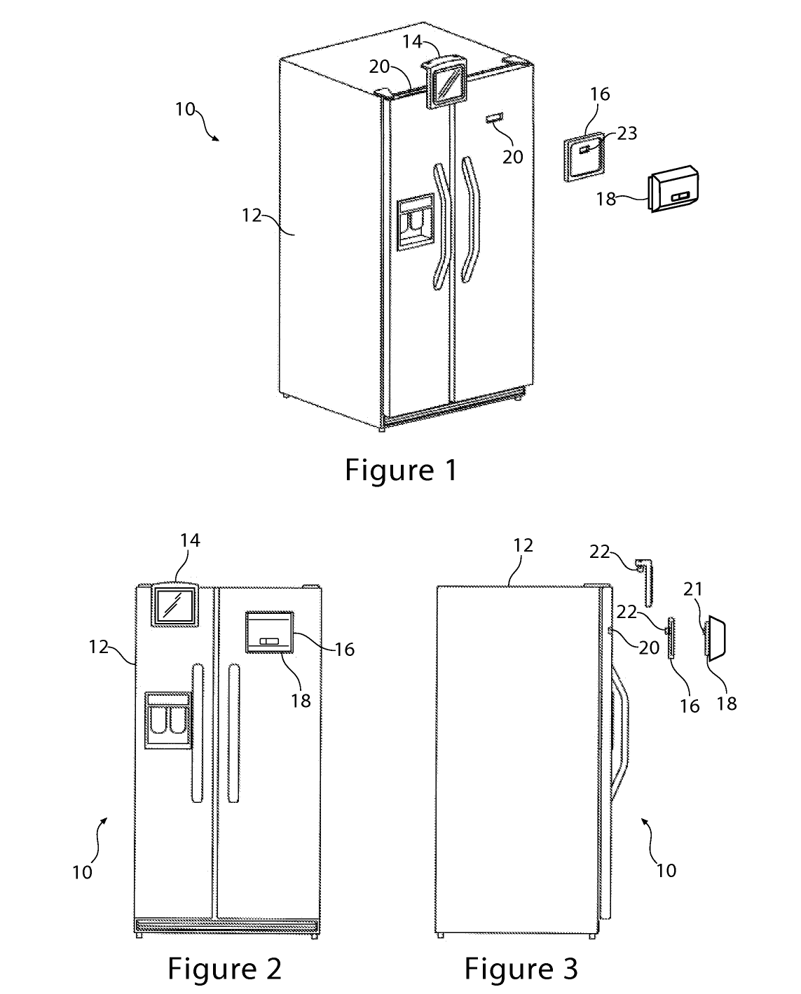

Referring now to FIGS. 1-3, a schematic illustration of a modular system 10 according to one embodiment of the invention is shown to include at least one host 12 and at least one accessory device 14 that can be coupled to host 12.

The accessory device 14 may be either directly or indirectly coupled to host 12. Direct coupling occurs when accessory device 14 includes an eService connector component suitably configured for engaging a corresponding eService connector component of host 12 to establish an eService pathway between the host 12 and the accessory device. 14. The eService pathway provides an eService line for transferring at least one eService from host 12 to accessory device 14 and from accessory device 14 to host 12.

An adapter 16 can be provided for coupling a second accessory device 18 having an incompatible eService connector component to host 12. An eService connector component is incompatible if it cannot be directly coupled to a corresponding eService connector component, such as when the incompatible eService connector component lacks certain physical features that would enable the eService connector component to engage the corresponding connector component to establish an eService pathway. Adapter 16 may include an eService connector component that can be directly coupled with the eService connector component of host 12 and a second eService connector component that can be directly coupled with the incompatible eService connector component of accessory device 18, thereby establishing an eService pathway between host 12 and accessory device 18.

Although accessory device 14 is shown coupled to an upper surface of host 12, whereas accessory device 18 is shown attached to a front surface of host 12 by way of adapter 16, it shall be appreciated that in practice, accessory device 14 and adapter 16 may be suitably configured for coupling to host 12 in any desired location and manner in order to accommodate the design and performance requirements of a particular application.

Host 12 may perform a primary function. As illustrated herein, host 12 is a refrigerator performing a cooling cycle and/or an ice making cycle. Although the figures show an appliance comprising a refrigerator, it shall be understood that the invention is not limited to refrigerators or appliances in general.

Accessory devices 14 and 18 may also perform at least one primary function. The primary function of accessory devices 14 and 18 will likely be different from the primary function performed by host 12, although it need not be. In the embodiment illustrated in the drawing, accessory device 18 may, for example, be a display selectively illuminated by an illumination service provided by host 12 or having a speaker selectively activated by an acoustical service provided by host 12 to provide information to a user. Alternatively, for example, accessory device 18 may be a substance holder, such as a dispenser, which contains a substance that is selectively heated by a thermal service provided by host 12.

Host 12 can be configured to provide or receive at least one eService to or from accessory devices 14 and 18. Similarly, accessory devices 14 and 18 may also be configured to provide or receive at least one eService to or from host 12. It is not necessary that the eService transferred between host 12 and accessory devices 14 and 18 be used in performing the primary function of host 12 or accessory devices 14 and 18, or otherwise be related to the primary function of either device.

As mentioned previously, in instances where the accessory device includes an incompatible eService connector component that prevents direct coupling of the accessory device to host 12, adapter 16 may be provided for indirectly coupling the accessory device to host 12. Adapter 16 operates to establish an eService pathway for transferring the desired eService between host 12 and accessory device 18 having the incompatible eService connector component. Adapter 16 may alternatively communicate a first type of service with host 12 and a second type of service with accessory device 18. For example, adapter 16 may receive electrical power service from host 12 and use that to create illumination service for accessory device 18 or receive electrical and thermal service from host 12 and use that to provide a substance to accessory device 18.

Accessory devices 14 and 18 and host 12 may each be eService communicating devices. At least one eService can be supplied to accessory devices 14 and 18 from host 12, or from accessory devices 14 and 18 to host 12. The supply of the eService can be uni-directional in that either host 12 supplies the eService to accessory devices 14 and 18 or accessory devices 14 and 18 supply the eService to host 12. The supply of the eService may alternatively be bi-directional in that the supplied eService can be delivered from host 12 to accessory devices 14 and 18 and from accessory devices 14 and 18 to host 12.

Host 12 and accessory device 14 may each be associated with at least one eService connector component, respectively referred to herein as a host eService connector component 20 and a device eService connector component 22. In the exemplary embodiment illustrated, host 12 comprises an eService provider and accessory device 14 comprises a portable eService consumer that functions as an accessory to host 12.

Host eService connector component 20 and device eService connector component 22 have complementary configurations that enable the eService connector components to be coupled to one another, thereby establishing an eService pathway over which desired eServices can be transferred between host 12 and accessory device 14. In instances where the accessory device includes an incompatible eService connector component, and an adapter 16 is used as an intermediate component to connect an accessory device 18 to a host 12, the adapter 16 will have a first device eService connector component 23 for engagement with a device eService connector component 21 of the accessory device 18, as well as a second device eService connector component 22 for connection with a second host eService connector component 20 of the host 12. Therefore, both device eService connector components 22 may have the same general configuration, whether included as part of accessory device 14 or adapter 16, and host eService connector component 20 may have the same general configuration whether it couples directly with an accessory device or an adapter. Accordingly, for purposes of discussion, the various features and operation of eService connector components 20 and 22 will hereinafter be described in connection with accessory device 14, but it shall be appreciated that device eService connector components 20 and 22 may also be used in conjunction with adapter 16.

Host eService connector component 20 can be integrally formed with host 12 or may be an add-on device. For purposes of discussion, host eService connector component 20 is shown integrally formed with host 12. When configured as an add-on device, host eService connector component 20 may also function as an adapter to enable a host and an accessory device having dissimilar eService connectors to be indirectly coupled to one another. Host eService connector component 20 may be removable or non-removable from host 12. Host eService connector component 20 can be configured to transfer or receive a single eService or multiple services.

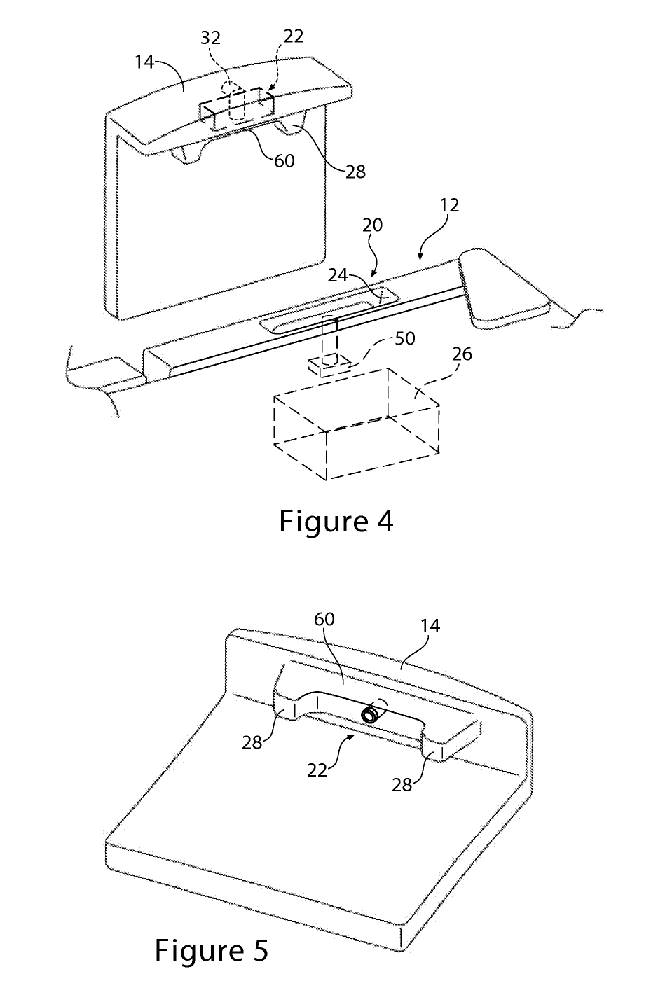

Referring to FIGS. 4 and 5, the host eService connector component 20 may be provided with a first eService connection component, such as a receptacle comprising a recess 24, proportioned to accept a second eService connection component, such as a plug comprising a pair of ridges 28 engageable with recess 24 to facilitate alignment of the eService connectors. It will be appreciated that ridges 28 are merely one example of the type of features that may be incorporated into host eService connector component 20 and device eService connector component 22 to aide alignment and coupling of accessory device 14 to host 12 and that host eService connector component 20 and device eService connector component 22 may include various features to facilitate coupling of accessory device 14 to host 12. In practice, other configurations may also be employed to accommodate various design considerations of a particular application.

Device eService connector component 22 may be integrally formed with accessory device 14 or may be an add-on component. For purposes of discussion, device eService connector component 22 is shown integrally formed with accessory device 14. When configured as an add-on component, device eService connector component 22 may also function as an adapter to enable a host and an accessory device having dissimilar eService connector components to be indirectly coupled to one another. Device eService connector component 22 may be removable or non-removable from accessory device 14. Similarly, device eService connector component 22 can be configured to transfer or receive a single eService or multiple services.

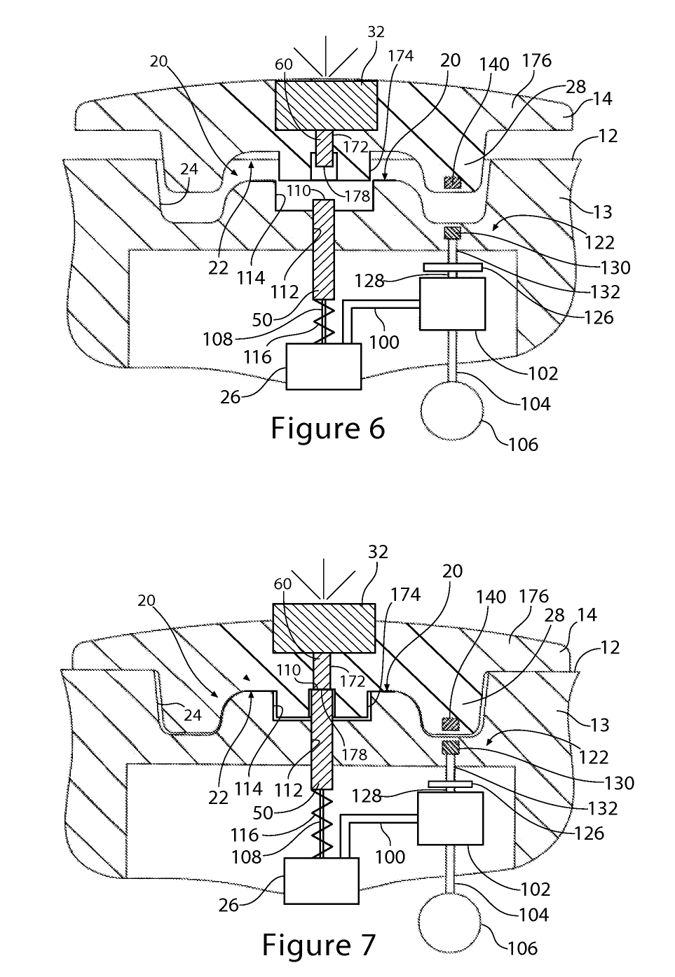

Host 12 may be provided with an eService provider 26 to selectively provide an eService to an eService transmitter 50. Accessory device 14 may be provided with an eService receiver to selectively receive an eService from eService transmitter 50 and an eService consumer 32 capable of using the eService received by the eService receiver or using another service to which the eService is converted. Each of these components will be described below in detail with reference to FIGS. 6 and 7.

Referring to FIGS. 6 and 7, eService provider 26 is provided with a first service to power and control eService provider 26. In particular, eService provider 26 may be connected by a line 100 to a controller 102, which is in turn connected by a line 104 to a power supply 106. At least one function of controller 102 is to act as a service switch to regulate the operation of eService provider 26.

It will be appreciated that the eService provider 26, controller 102, and/or power supply 106 may integrated into host 12 or provided in other devices in communication with host 12. In the illustrated embodiment, they are provided within a housing 13 of host 12. For some applications, eService provider 26 may incorporate controller 102 and may be connected directly to power supply 106. EService provider 26 is connected by a line 108 to eService transmitter 50.

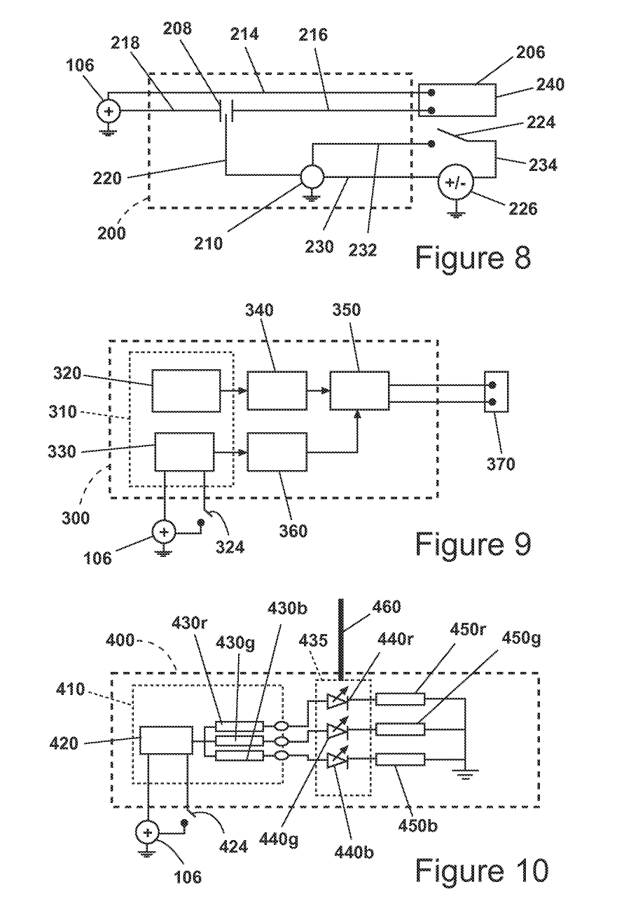

It should be noted that eService provider 26 may be any type of eService provider and the first service may be any eService directly transmitted by eService transmitter 50. For example, eService provider 26 may be a thermal service provider 200 (see FIG. 8), and service line 108 and eService transmitter 50 may be heat conductive rods or wires. EService provider 26 may alternatively be an acoustic service provider 300 (see FIG. 9), and service line 108 and eService transmitter 50 may be sound conductive rods or wires. EService provider 26 may alternatively be an illumination service provider 400 (see FIG. 10), and service line 108 and eService transmitter 50 may be light pipes. These eService providers 200, 300 and 400 will be described later herein.

With continued reference to FIGS. 6 and 7, it will be appreciated that, in addition to eService provider 26 being a potential provider of sound, illumination or heat, eService provider 26 may be a source of data, such as a source of fiber optic data, and a switch, such as a fiber optic switch for enabling the exchange of the fiber optic data between two eService communication devices.

It will further be appreciated that service line 108 or transmitter 50 may comprise a portion of the eService provider 26 by, for example, incorporating cal-rods, LEDs, sound generators, image generators, hologram generators, or other wave generating or transmitting features governed by eService provider 26. In the case of a sound generator, eService provider 26 may be a source of acoustic information using DTMF tones or Morse code for transmission, thereby creating an acoustic data network when controller 102 is actuated. In the case of an image generator, eService provider 26 may project an image, such as a “smiley face” image. In this case, eService transmitter 50 might be a translucent film that has the smiley face image encoded on it such that when controller 102 is actuated, eService provider 26 supplies light to through eService transmitter 50, thereby causing the image to be projected to accessory device 14.

Alternatively, eService provider 26 may be different type of service provider, such as an AC to DC converter, providing a first service to eService transmitter 50. In this instance, eService transmitter 50 may function as both an eService provider and as an eService transmitter by using the first service, such as direct current electrical power, to create an eService, such as by heating a heat conducting wire, generating light and sending it into a light pipe, or generating an acoustical wave and sending it along a vibration conducting rod.

EService transmitter 50 has an exposed end 110 extended through a bore 112 in housing 13 of host 12 and into an enlarged counter bore 114 formed in the outwardly facing portion of housing 13. Enlarged counter bore 114 may act as a receptacle for a plug associated with accessory device 14, as will be described below. Where appropriate and practical for the type of service line 108, service line 108 may have a sliding engagement with eService transmitter 50 or may be flexible to permit some relative movement between eService transmitter 50 and eService provider 26. A biasing means, such as a spring 116, may be provided to bias eService transmitter 50 away from eService provider 26 to facilitate proper engagement of eService transmitter 50 with an eService receiver 60 when the eService connector components 22 and 20 are engaged.

Controller 102 may have any of a variety of configurations depending on the application. In some applications, controller 102 may be an electrically powered processor using power from power supply 106 to make control decisions for eService provider 26 and supplying power useful for the operation of eService provider 26. In other applications, power supply 106 may itself provide an eService and controller 102 may comprise a switch to selectively permit or prevent the flow of the eService to eService provider 26.

More particularly, as illustrated, controller 102 may control the operation of eService provider 26 by selectively completing a circuit with power supply 106 and eService provider 26 by selectively connecting service lines 100 and 104 to power supply 106. Alternatively, controller 102 may directly control the operation of power supply 106 by way of service line 104. Alternatively, eService provider 26 may be connected by power lines, not shown, to power supply 106 and may receive only a data signal from controller 102. In the later type of application, eService provider 26 may have some functionality independent of controller 102. For example, eService provider 26 may provide a low intensity illumination service at a first frequency independent of controller 102 but may provide a higher intensity light of varying frequency illumination in response to a control signal from controller 102.

Host 12 may also be provided with a switched service connector system employing a proximity switch 122 and one or more service line(s) 128 connecting proximity switch 122 to controller 102 and capable of communicating a signal for selectively controlling the operation of controller 102.

Proximity switch 122 includes a proximity sensor 130 connected by one or more service line(s) 132 to a receiver 126. It will be appreciated that proximity sensor 130 may have any of a variety of configurations depending on the requirements of the particular application. In the embodiment shown in FIGS. 6 and 7, proximity sensor 130 is a magnetic sensor molded into housing 13 and capable of detecting a magnetic field and generating a signal or current in response to the detection of a magnetic field. Receiver 126 may be connected by line 128 to controller 102 to provide a signal indicative of the detection by proximity sensor 130 of a proximity target, described shortly, or may alternatively be incorporated into controller 102.

The proximity sensor 130 may alternatively be configured, for example, to sense an electromagnetic or acoustic wave, a visual target, a temperature or a chemical. The communication along service line 132 may be, for example, by means of an electrical signal, an acoustic or electromagnetic wave, or a physical displacement of a linking member.

With continued reference to FIGS. 6 and 7, as previously mentioned, accessory device 14 has an eService consumer 32 and an eService receiver 60. In the example illustrated, eService receiver 60 is shown schematically as a rod-like structure coupled directly to eService consumer 32 that directly uses the eService provided by eService receiver 60. For example, if eService receiver 60 receives an illumination service, eService receiver 60 may be a light pipe and eService consumer 32 may be a light conductive device illuminated by the receipt of the illumination service from eService receiver 60 to provide an illuminated display for a user. If eService receiver 60 receives an acoustic service, eService consumer 32 may be a speaker amplifying and re-broadcasting sound to a user. If the eService receiver 60 is a thermal service receiver, eService consumer 32 may be a heat conductive surface or a heat conductive wire directing the thermal service, for example, to the contents of a substance holder such as a bottle or a storage compartment.

It should be noted that the generically illustrated configuration is not intended to depict any particular configuration, but rather schematically represents a variety of potentially different configurations. In practice, the actual configuration will likely vary depending on, at least in part, the type of eService being transferred, space and power requirements, and manufacturing considerations. For example, acoustical transmission may require more contact surface area at coupling points such as between transmitter 50 and eService receiver 60 at the ends of service line 108 and between eService receiver 60 and eService consumer 32.

It should also be noted that, while the embodiment shows an eService consumer 32 directly coupled to eService receiver 60 and using the eService as received by eService receiver 60, other configurations are contemplated.

For example, where appropriate, a service line (not shown) may be provided between eService receiver 60 and eService consumer 32. For some applications, a conversion device (not shown) may be provided between eService consumer 32 and eService receiver 60 converting the output of eService receiver 60 to a service that may be used by eService consumer 32. Alternatively, a conversion device may be incorporated into eService receiver 60 or eService consumer 32. For example, a conversion device may be provided to convert illumination containing data into an electromagnetic service carrying data. EService consumer 32 may consume the eService for an internal operation of accessory device 14 or may relay the eService or a converted service to a second accessory device, such as accessory device 18 (see FIGS. 1-3). In still another instance, eService consumer 32 may be a component of an accessory device 18, which is only coupled to eService receiver 60 when accessory device 18 is removably coupled to accessory device 14.

EService receiver 60 extends through a bore 172 in a plug 174 formed on an external surface of a housing 176 of accessory device 14 and terminates in an exposed end 178 engageable with exposed end 110 of eService transmitter 50 for the selective communication of eService therebetween. EService transmitter 50 moves against spring 116 to take up any tolerance between eService transmitter 50 and eService receiver 60 and to bias exposed ends 110 and 178 into engagement. Plug 174 is proportioned to fit inside the receptacle formed by counter bore 114 in housing 13 of host 12 when accessory device 14 is coupled with host 12.

Accessory device 14 is further provided with a proximity target 140 engageable with proximity switch 122 when accessory device 14 is coupled to host 12. As depicted, proximity target 140 may be a magnet molded into housing 176 which may be detected by proximity sensor 130 described above when accessory device 14 is coupled with host 12.

It should be noted that housing 176 may be an integral part of accessory device 14 or may be a separate component. For purposes of discussion, housing 176 is illustrated as an integral part of accessory device 14.

Coupling of accessory device 14 to host 12 can be easily accomplished. When accessory device 14 is coupled to host 12, ridge 28 enters recess 24, plug 174 enters counter bore 114, and eService transmitter 50 operably engages eService receiver 60, as shown in FIG. 7. The process of coupling accessory device 14 to host 12 further causes proximity sensor 130 to detect proximity target 140, causing proximity switch 122 to provide a signal to controller 102 indicating that a connection has been made. Controller 102 responds to the signal by selectively powering or operating eService provider 26 or by sending a control signal to eService provider 26 indicating that a connection has been made.

Decoupling accessory device 14 from host 12 disengages proximity switch 122 and interrupts the transmission of the control signal to service switch 102, thereby deactivating the service switch.

Referring to FIGS. 8, 9 and 10, other embodiments of eService providers are illustrated schematically. FIG. 8 shows thermal service provider 200. FIG. 9 shows acoustic service provider 300, FIG. 10 shows illumination service provider 400.

As shown in FIG. 8, thermal service provider 200 may include a heat generator 206 and contacts 208 of a relay 210 for switching power to the heat generator connected in series with power supply 106. Heat generator 206 may produce or pass on current to heat a transformer, such as a resistance-type heater (not shown), using electrical resistance to generate heat from current flowing through heat generator 206. Power supply 106 is selected to have a high wattage output sufficient to enable heat generator 206 to generate a desired level of heat.

More particularly, a first side of power supply 106 is connected by a power line 214 to a first side of heat generator 206, a second side of heat generator 206 is connected by a power line 216 to a first side of contacts 208, and a second side of contacts 208 is connected by a power line 218 to a second side of power supply 106.

Relay 210 is connected to contacts 208 by a mechanical coupling 220 operable to selectively complete the circuit between power supply 106 and heat generator 206. Relay 210 is connected in series with a low wattage power supply 226 and service switch 224. More particularly, a first side of low wattage power supply 226 is connected by a power line 230 to a first side of relay 210, a second side of relay 210 is connected by a power line 232 to a first side of service switch 224 and a second side of service switch 224 is connected by a power line 234 to a second side of low wattage power supply 226. Thus, when service switch 224 is closed, relay 210 is powered by low wattage power supply 226.

Mechanical coupling 220 may include a plunger (not shown), which moves according to the attractive magnetic forces created by the current flowing through the coil of relay 210. The plunger is mechanically coupled to high current contacts 208 with power lines 218 and 216 such that when the plunger moves in response to the current flow, the high current contacts are mechanically brought into electrical communication. Thus, relay 210 actuates to close contacts 208 to permit the flow of current to heat generator 206. It will be appreciated that there may be additional switches and logic regulating the supply of power from high wattage power supply 106 to heat generator 206, and contacts 208 may act as one of a plurality of switches that must be closed before heat generator 206 is powered.

The heat generator 206 includes a heat conductive surface 240 capable of communicating heat to another device. Thus heat generator 206 may be coupled with or may comprise a thermal eService transmitter 50 (see FIGS. 6 and 7), which may transmit thermal energy to a thermal eService receiver 60. The eService transmitter 50 may conduct heat when the current to heat transformer 206 generates heat.

As shown in FIG. 9, acoustical service provider 300 may include a microprocessor 310 having an input circuit connected with power supply 106 through a service switch 324. When service switch 324 closes, the input of the microprocessor 310 changes state, thereby informing the logic of the microprocessor 310 that service switch 324 is closed.

Microprocessor 310 includes a sound source 320, which may be a sound generator or a sound processor connected to an external source of sound data in any digital or analog format. Microprocessor 310 further includes logic 330 for controlling the operation of the acoustical service provider 300. The output of sound source 320 is delivered, for example, through a digital-to-analog converter 340, which in turn delivers an electrical sound wave input to an amplifier 350.

Logic 330 is configured to respond to the information regarding the status of service switch 324 by enabling another digital-to-analog converter 360 to send a control analog signal to amplifier 350, which controls the level of the signal output of the amplifier, thereby effectively operating as an acoustic switch. Amplifier 350 receives the electrical sound input wave from sound source 320 and creates an amplified electrical sound output wave having an amplitude determined by the electrical sound input wave and the level of amplification indicated by the analog signal.

The sound output wave is then received by a speaker 370, which is coupled to the output of amplifier 350 and converts the output into a sound wave, which can be transmitted to an eService receiver, such as a microphone (not shown). Speaker 370 thereby serves as an eService transmitter.

As shown in FIG. 10, illumination service provider 400 may include a microprocessor 410 having an input circuit connected with power supply 106 through a service switch 424. When service switch 424 closes, the input of microprocessor 410 changes state, thereby informing logic 420 of the microprocessor 410 that service switch 424 is closed. The logic 420 of microprocessor 410 is configured to respond to this information by allowing the logic 420 to determine the color and intensity of the light to be created by illumination service provider 400 in a manner described below.

Microprocessor 410 includes three pulse-width modulation (PWM) modules 430r, 430g and 430b, which can create PWM electrical signals. Each PWM module 430r, 430g, and 430b is associated with a particular output circuit of microprocessor 410. The output of each PWM module 430r, 430g and 430b is connected to one of three LEDs; red LED 440r, green LED 440g and blue LED 440b. The output of each LED 440r, 440g and 440b is combined and directed to a light pipe 460, which serves as an illumination eService transmitter. Each LED 440r, 440g and 440b is connected to ground through a resistor 450r, 450g and 450b.

The color transmitted from the light pipe 460 is determined by the relative proportions of the light each LED 440r, 440g and 440b generates. In particular, logic 420 controls each PWM module 430r, 430g and 430b such that each LED 440r, 440g and 440b receives a signal for a portion of time. Each LED 440r, 440g and 440b emits light at a magnitude proportional to the portion of time that the signal is received. A resultant color is created by the relative contribution of emitted light each LED 440r, 440g and 440b. Therefore, the resultant color output is controlled by the logic that controls the portion of time each PWM module 430r, 430g and 430b is sending the signal.

The intensity of the resultant color light transmitted from the LEDs 440r, 440g and 440b to light pipe 460 is also a proportional sum of the portions of time each PWM module 430r, 430g and 430b is sending the signal.

Therefore, the color and intensity of the resultant light provided to light pipe 460 may be controlled by logic 420 in response to the actuation of the service switch 424 by controlling the intensity of the light emitted by each of the LEDs relative to one another and the absolute intensity of the light emitted by all of the LEDs.

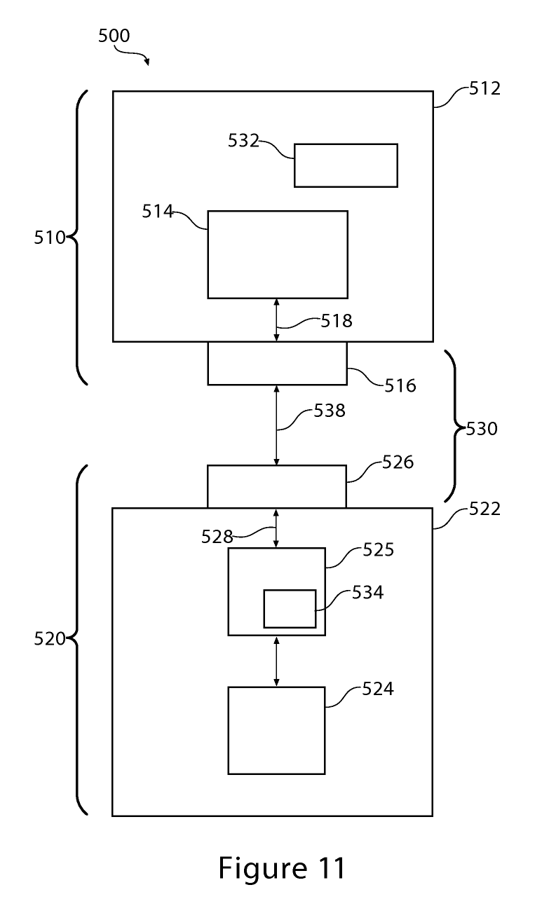

Referring now to FIG. 11, a more general example of an eService provider and consumption system 500 is schematically illustrated. A first subsystem 510 is connectable to a second subsystem 520 for selectively transferring an eService between the subsystems 510 and 520. As illustrated, first subsystem 510 may include an accessory device 512, such as a portable device, having an eService consumer 514 connected to a plug 516 by an eService line 518. Second subsystem 520 may include a host 522, such as a refrigerator, having an eService provider 524 connected to a receptacle 526 through a service switch 525 by eService line 528.

A connector system 530 includes plug 516 and receptacle 526, which are selectively interengageable. A proximity target 532 and a proximity sensor 534 are respectively associated with first subsystem 510 and second subsystem 520 to selectively activate the service switch 525 when the plug 516 and receptacle 526 are engaged to permit the flow of the eService from the eService provider 524 to the receptacle 526, so that it may subsequently be provided along an eService line 538 between receptacle 526 and plug 516, and then along eService line 518 to eService consumer 514.

It will be appreciated that while host 522 is illustrated as including eService provider 524 and accessory device 512 is illustrated as including eService consumer 514, accessory device 512 may be alternatively or additionally include an eService provider and host 522 may alternatively or additionally include an eService consumer. It will further be appreciated that while plug 516 is illustrated as being associated with eService consumer 514 and receptacle 526 is illustrated as being associated with eService provider 524, it is contemplated that plug 516 and receptacle 526 may be male or female connector components so long as the components are capable of interengaging to permit the transfer of eService therebetween.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In summary, it should be understood that the invention is capable of modification and variation and is limited only by the following claims.

All defined terms used in the claims are intended to be given their broadest reasonable constructions consistent with the definitions provided herein. All undefined terms used in the claims are intended to be given their broadest reasonable constructions consistent with their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A system for coupling eService communicating devices, the system comprising:
a first eService connector component associated with a first eService communicating device having a proximity target;
a second eService connector component operably engageable with the first eService connector component, the second eService connector component associated with a second eService communicating device having a proximity sensor;
an eService pathway passing an eService between the first and second eService connector components when the eService components are interengaged; and
a service switch operably associated with the proximity sensor to selectively permit the flow of the eService along the eService pathway when the proximity sensor detects the proximity target.

2. The system according to claim 1, wherein one of the first and second eService connector components comprises an eService plug and the other of the first and second eService connector components comprises an eService receptacle.

3. The system according to claim 1, wherein in the service switch selectively permits the flow of eService to the services pathway in response to the detection of the proximity target by the proximity sensor.

4. The system according to claim 1, wherein the service switch selectively forms the service pathway in response to the detection of the proximity target by the proximity sensor.

5. The system according to claim 4, wherein the eService pathway comprises an eService line for selectively transferring the eService from the second eService communicating device to the second eService connector component, the eService line being movable between a first position, in which the eService line is operably decoupled from the second eService connector component, and a second position, in which the eService line is operably coupled with the second eService connector component, wherein the eService line is arranged in the first position when the proximity sensor does not detect the proximity target.

6. The system according to claim 1, wherein the proximity target and the proximity sensor are magnetic, and the service switch responds to movement of the proximity sensor in response to the detection of the proximity target by the proximity sensor.

7. The system according to claim 1 and further comprising a host configured to communicate at least one eService to the first eService communicating device.

8. The system according to claim 7, wherein the host comprises at least one of a refrigerator, a freezer, a conventional oven, a microwave oven, a dishwashing machine, a stove, a range, an air conditioner, a dehumidifier, a clothes washing machine, a clothes dryer, a clothes refreshing machine, a non-aqueous washing apparatus, a water softener, a water heater, a furnace, pool water treatment equipment, an HVAC system, a thermostat, a blender, a mixer, a toaster, a coffee maker, an air purifier, an iron, a vacuum cleaner, a robot, a trash compactor and a structural feature of a building.

9. The system according to claim 8, further comprising a portable accessory device comprising the second eService communicating device.

10. The system according to claim 1, further comprising a functional unit including the eService communicating device.

11. The system according to claim 1 wherein the proximity sensor is selected from a magnetic sensor, a light sensor, an optical sensor, an eddy current sensor, an acoustic sensor, an eService sensor, a chemical sensor, and a thermal sensor.

12. The system according to claim 1 wherein the proximity target is selected from a passive target and thermal sensor.

13. The system according to claim 1, wherein the proximity sensor is selected from a passive sensor and an active sensor.

14. The system according to claim 1, wherein the eService comprises an illumination service.

15. The system according to claim 1, wherein the eService comprises an acoustical service.

16. The system according to claim 1, wherein the eService comprises a thermal service.

17. The system according to claim 1, wherein the service switch comprises a controller having a processor for regulating the operation of an eService provider.

18. An eService connector component for connecting a portable device to a host, the portable device having a proximity target and an eService communicating device, the eService connector component comprising:
a proximity sensor capable of detecting the proximity target;
an eService pathway interconnecting the eService communicating device and the eService connector component; and
a service switch selectively permitting the flow of the eService along the eService pathway in response to detection of a proximity target by the proximity sensor.

19. The eService connector component according to claim 18, and further comprising an interface operably connected to an eService source.

20. The eService connector component according to claim 18, and further comprising at least one of an eService plug and an eService receptacle.

21. The eService connector component according to claim 18, wherein in the service switch selectively forms the eService pathway in response to the detection of the proximity target by the proximity sensor.

22. The eService connector component according to claim 18, wherein at least one of the proximity target and the proximity sensor is a magnet.

23. The eService connector component according to claim 18, wherein the proximity sensor responds to detection of the proximity target by sending a signal to the service switch.

24. The eService connector component according to claim 23 wherein the signal comprises at least one of a change in an eService field, an eService wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and a presence of a chemical.

25. The eService connector component according to claim 18, wherein the proximity sensor detects at least one of a change in an eService field, an eService wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and a presence of a chemical.

26. The eService connector component according to claim 18, wherein the proximity target comprises a magnet, the proximity sensor comprises a magnet, and the service switch is powered at least partially by the magnetic interaction between the proximity sensor and the proximity target.

27. The eService connector component according to claim 18, wherein the eService comprises an illumination service.

28. The eService connector component according to claim 18, wherein the eService comprises an acoustical service.

29. The eService connector component according to claim 18, wherein the eService comprises a thermal service.

30. The eService connector component according to claim 18, wherein the service switch comprises a controller having a processor for regulating the operation of an eService provider.

31. A portable accessory device for use in association with a host having an eService provider, a first eService connector component, and an eService line selectively providing an eService to the first eService connector component in response to a proximity sensor detecting a proximity target, the accessory device comprising:
an eService consumer;
a second eService connector component;
an eService pathway for interconnecting the eService consumer and the second eService connector component; and
a proximity target capable of activating the proximity sensor to activate a service switch;
wherein the activation of the service switch permits the provision of the eService from the second eService connector component to the eService consumer along the eService pathway.

32. The accessory device according to claim 31, further comprising a housing wherein the eService consumer, the eService pathway and the proximity target are each at least partially disposed with the housing.

33. The accessory device according to claim 31, further comprising an adapter, the eService consumer further comprising a device capable of being removably coupled to the adapter.

34. The accessory device according to claim 33 wherein the eService consumer is at least one of a consumer electronic device, a client software device, a remote user interface, a source of consumer information, a reader, a sensor device, a smart utensil, an appliance, an additional smart coupling device, a remote controller, a network binder, a cycle accessory, a resource controller, a communicator, an access system, a payment system, a sales demonstration device, and an eService device.

35. The accessory device according to claim 31, wherein the proximity target provides at least one of a change in an eService field, an eService wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and a presence of a chemical.

36. The accessory device according to claim 31, wherein the proximity target is selected from a passive target and an active target.

37. The accessory device according to claim 31, wherein the proximity target is a magnet.

38. An adapter for removably coupling a portable eService communicating device having a first device eService connector component to a host eService communicating device having a first host eService connector component that cannot be directly connected to the first device eService connector component and a first contactless proximity coupling device, the adapter comprising:
a second host eService connector component engageable with the first host eService connector component;
a second device eService connector component engageable with the first device eService connector component;
an eService pathway interconnecting the second host eService connector component and the second device eService connector component for the transfer of an eService therealong; and
a second contactless proximity coupling device operably associated with the second host eService connector component, the second contactless proximity coupling device being configured to engage the first contactless proximity coupling device when the first and second eService connector components are engaged to selectively permit the communication of the eService between the first eService communicating device and the second eService communicating device.

39. The adapter according to claim 38 wherein:
the first contactless proximity coupling device comprises a proximity sensor and a service switch selectively providing an eService between the host eService connector components in response to a proximity sensor engaging a proximity target; and
the second contactless proximity coupling device comprises a proximity target capable of engaging the contactless proximity sensor to actuate the eService switch.

40. The adapter according to claim 39, wherein the proximity target provides at least one of a change in an eService field, an eService wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and a presence of a chemical.

41. The adapter according to claim 39, wherein the proximity target is selected from a passive target and an active target.

42. A second eService communicating device for coupling to a first eService communicating device having a first eService connector component, an eService receiver capable of receiving at least one eService, and a first service switch component, the second eService communicating device comprising:
a second eService connector component comprising an eService transmitter capable of transmitting the at least one eService; and
a second service switch component engageable with the first service switch component to selectively control the transmission of eService from the second eService connector component in response to the engagement between the second and the first service switch components.

43. The second eService communicating device according to claim 42, wherein the eService is provided by an eService generator connected to a power supply through a power switch, and the second service switch component selectively controls the operation of the eService generator by operating the power switch to selectively provide the eService generator with power in response to engagement with the first service switch component.

44. The second eService communicating device according to claim 42, wherein the eService is provided by an eService generator connected to a controller, and the second service switch component selectively sends a signal to the controller affecting the operation of the eService generator in response to engagement with the first service switch component.

45. The second eService communicating device according to claim 44, wherein the controller selectively controls a characteristic of the eService in response to the signal.

46. The second eService communicating device according to claim 45, wherein the characteristic is at least one of intensity and frequency.

47. The second eService communicating device according to claim 42, wherein the eService comprises an illumination service.

48. The second eService communicating device according to claim 42, wherein the eService comprises an acoustical service.

49. The second eService communicating device according to claim 42, wherein the eService comprises a thermal service.

50. The second eService communicating device according to claim 42, wherein the first service switch component comprises a proximity target and the second service switch component comprises a proximity sensor.

51. The second eService communicating device according to claim 50, wherein the first service switch component comprises a contactless proximity target and the second service switch component comprises a contactless proximity sensor.

52. The second eService communicating device according to claim 42 and further comprising:
an eService provider connected to the second eService connector component and capable of selectively providing eService to the eService transmitter; and
a controller connected to the second service switch component and the eService provider, the controller being capable of controlling the operation of the eService provider in response to the engagement of the second service switch component with the first service switch component.

53. The second eService communicating device according to claim 52, wherein the eService provider is an illumination generator and the eService transmitter comprises a light pipe.

54. The second eService communicating device according to claim 52, wherein the eService provider is a heat generator and the eService transmitter comprises a heat conductive member.

55. The second eService communicating device according to claim 52, wherein the eService provider is a sound generator and the eService transmitter comprises a speaker.

56. A system of communicating devices comprising:
an accessory having a first eService communicating device, the first eService communicating device comprising:
a first eService connector component comprising an eService receiver capable of receiving at least one eService; and
a first service switch component; and
a host having an eService coupling system, the coupling system comprising:
a second eService connector component comprising an eService transmitter capable of transmitting the at least one eService; and
a second service switch component engageable with the first service switch component to selectively control the transmission of eService from the second eService connector component.

57. The system of communicating devices according to claim 56, wherein the host further comprises:
an eService provider connected to the second eService connector component and capable of selectively providing eService to the eService transmitter; and
a controller connected to the second service switch component and the eService provider, the controller being capable of controlling the operation of the eService provider in response to the engagement of the second service switch component with the first service switch component.

58. The system of communicating devices according to claim 57, wherein the eService provider is an illumination generator, the eService transmitter comprises a light pipe, and the eService receiver comprises a light pipe.

59. The system of communicating devices according to claim 57, wherein the eService provider is a heat generator, the eService transmitter comprises a heat conductive member, and the eService receiver comprises a heat conductive member.

60. The system of communicating devices according to claim 57, wherein the eService provider is a sound generator, the eService transmitter comprises a speaker, and the eService receiver comprises a microphone.

61. A host for coupling to an accessory device, the host comprising:
an eService connector component;
an eService transmitter operably connected to the eService connector component and capable of transmitting the at least one eService to the accessory device; and
a service switch component to selectively control the transmission of eService from the appliance to the accessory device.

62. The host according to claim 61, wherein the host is an appliance that performs a physical operation on an article.

63. The host according to claim 62, wherein the appliance comprises at least one of a refrigerator, a freezer, a conventional oven, a microwave oven, a dishwashing machine, a stove, a range, an air conditioner, a dehumidifier, a clothes washing machine, a clothes dryer, a clothes refreshing machine, a non-aqueous washing apparatus, a blender, a mixer, a toaster, a coffee maker, an air purifier, and a trash compactor.

64. The host according to claim 61, wherein the host comprises at least one of a water softener, a water heater, a furnace, pool water treatment equipment, an HVAC system, a thermostat, an iron, a vacuum cleaner, and a robot.
